(19) United States
(12) Patent Application Publication
(10) Pub. No.: US 2017/0320200 A1
(43) Pub. Date: Nov. 9, 2017

(54) SCREWDRIVER

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YU FANG, Shenzhen (CN); FENG ZHEN, Shenzhen (CN); TAI-SHAN ZHU, Shenzhen (CN)

(21) Appl. No.: 15/484,142

(22) Filed: Apr. 11, 2017

(30) Foreign Application Priority Data
May 4, 2016 (CN) 201610292814.6

(51) Int. Cl. B25B 23/00; B25B 15/00; B25G 1/10

(52) U.S. Cl. CPC B25B 23/0035; B25G 1/102; B25B 15/005; B25B 15/007; B25B 15/008

(57) ABSTRACT

A screwdriver capable of driving screws with any shape of head comprises a fixing member and a main body. The main body comprises a first end and a second end, the fixing member fixes on the first end of the main body. The screwdriver further comprises a number of hard and small-diameter cores and a button. The cores are contained in the main body and are partially exposed out of the main body, the button is configured on the second end of the main body and resists against one end of the number of cores. The button drives a part of the number of cores to form a head to match a screw.

### CROSS-REFERENCE TO RELATED APPLICATIONS

This application claims priority to Chinese Patent Application No. 201610292814.6 filed on May 4, 2016 in the China Intellectual Property Office, the contents of which are incorporated by reference herein.

### FIELD

The subject matter herein generally relates to screwdrivers.

### BACKGROUND

Generally, different types of screwdrivers can fasten different types of screws. Thus high cost is caused to user with many different types of screwdriver being necessary.

### BRIEF DESCRIPTION OF THE DRAWINGS

Implementations of the present disclosure will now be described, by way of example only, with reference to the attached figures.

FIG. 1 illustrates an isometric view of one exemplary embodiment of a screwdriver.

FIG. 2 illustrates a cross-sectional view of one exemplary embodiment of the screwdriver of FIG. 1.

FIG. 3 illustrates an exploded view of one exemplary embodiment of the screwdriver of FIG. 1.

FIG. 4 illustrates an isometric view of one exemplary embodiment of a line shaped head that is formed by the screwdriver of FIG. 1 when the screwdriver of FIG. 1 fastens a line shaped screw.

FIG. 5 illustrates an isometric view of one exemplary embodiment of a cross shaped head that is formed by the screwdriver of FIG. 1 when the screwdriver of FIG. 1 fastens a cross shaped screw.

FIG. 6 illustrates an isometric view of one exemplary embodiment of a hexagon shaped head that is formed by the screwdriver of FIG. 1 when the screwdriver of FIG. 1 fastens a hexagon shaped screw.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series and the like.

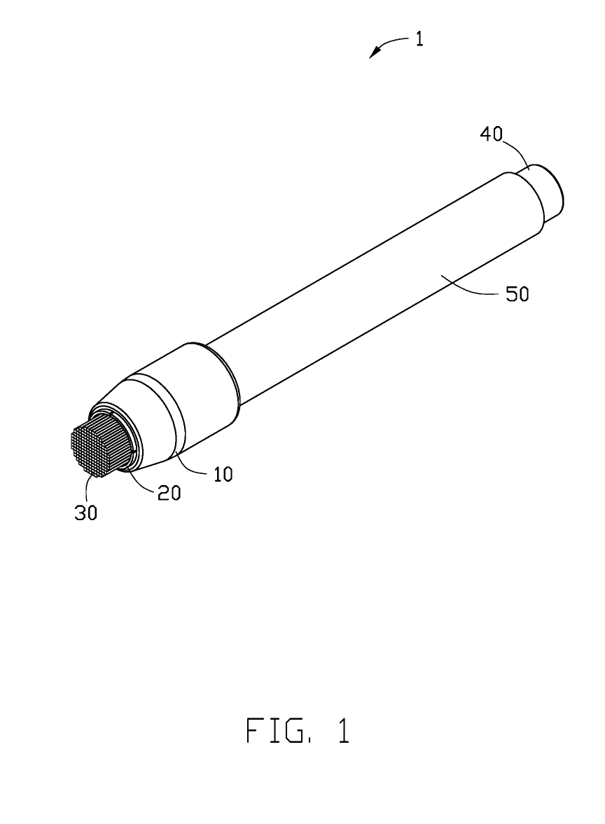

FIG. 1 shows an isometric view of one exemplary embodiment of a screwdriver 1. Depending on the embodiment, the screwdriver 1 can include, but is not limited to, a fixing member 10, a main body 20, a number of cores 30, and a button 40.

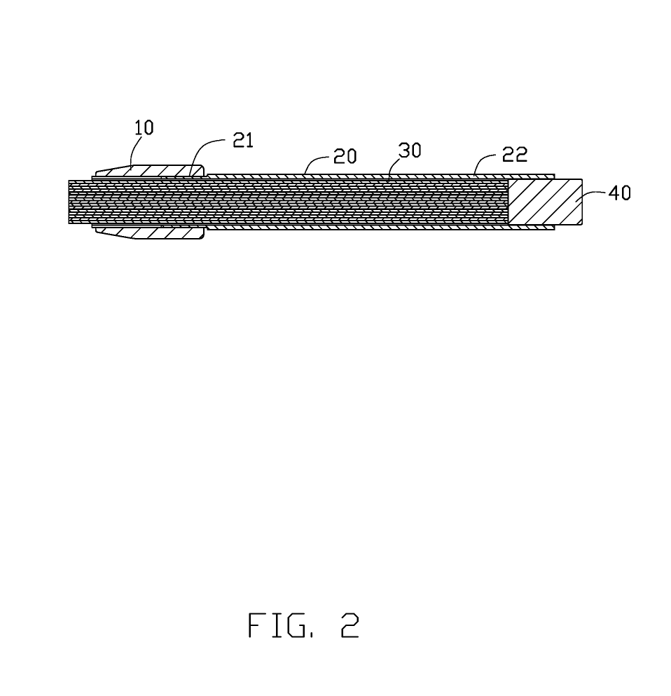

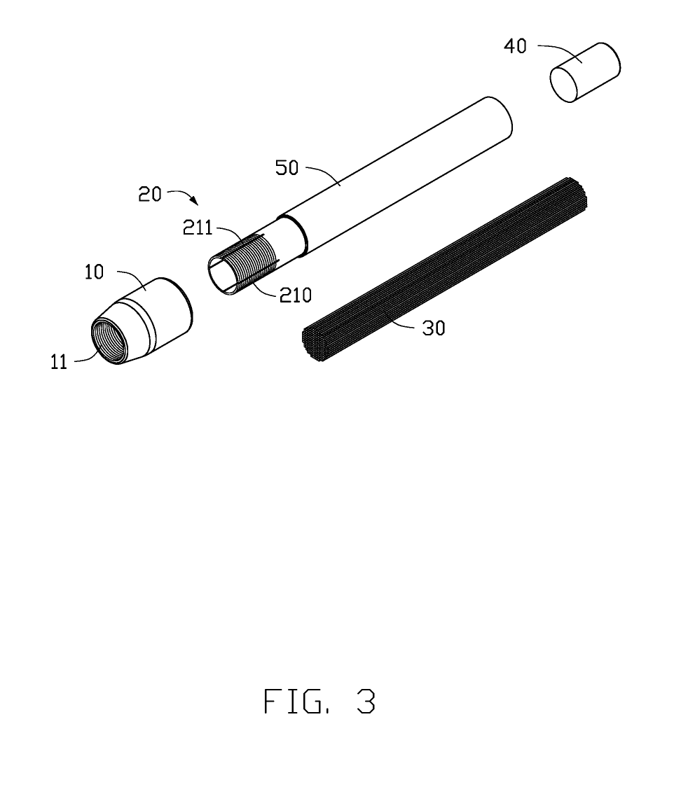

Referring FIG. 2 and FIG. 3, the fixing member 10 can be a hollowed cone body. First screw thread 11 is set on an internal surface of the fixing member 10. In at least one exemplary embodiment, the main body 20 can be a hollowed cylinder. The main body 20 includes a first end 21 and a second end 22. Second screw thread 210 is set on an external surface of the main body 20. The second screw thread 210 matches the first screw thread 11, and the matching between the first screw thread 11 and the second screw thread 210 is configured to fix the fixing member 10 on the first end 21 of the main body 20.

The number of cores 30 are contained in the main body 20. In at least one exemplary embodiment, the number of cores 30 are hard and have small-diameter. In at least one exemplary embodiment, the number of cores 30 are partially exposed out of the main body 20. When the number of cores 30 are squeezed by the main body 20, the number of cores 30 are in contact with each other and thus a cylinder is formed therebetween. In at least one exemplary embodiment, a number of through grooves 211 are defined in the first end 21 of the main body 20. In at least one exemplary embodiment, the number of through grooves 211 are parallel and equidistant from each other. In at least one exemplary embodiment, a total number of the through grooves 211 equals four, five, or six. When the fixing member 10 is fixed on the main body 20, the number of through grooves 211 being squeezed by the fixing member 10 cause the number of through grooves 211 to be in close contact with each other. Positional offset of the number of through grooves 211 is prevented. In at least one exemplary embodiment, a cross section of each of the number of cores 30 has a square shape. In other exemplary embodiments, the cross section of each of the number of cores 30 has a hexagon shape, or another polygon shape.

The button 40 is configured on the second end 22 of the main body 20. A first end of the button 40 resists against a first end of the number of cores 30, and a second end of the button 40 is exposed out of the second end 22 of the main body 20. In at least one exemplary embodiment, the button 40 has a cylinder shape and is made of elastic material.

Refer to FIG. 1, in at least one exemplary embodiment, the main body 20 is enclosed by a cover 50, except for the first end 21. The cover 50 can be made of anti-slip material, thus it is easy for a user to hold the main body 20. In other exemplary embodiments, the main body 20 is configured with screw thread except for the first end 21, thus an anti-slip feature can be achieved.

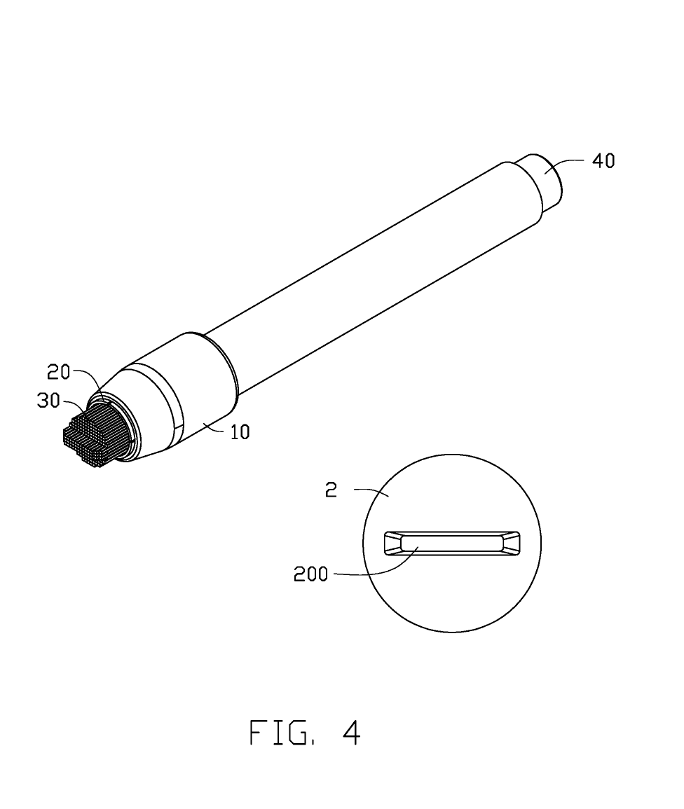

Refer to FIG. 4, when the user uses the screwdriver 1 to fasten a slot-headed screw (a line shaped screw 2), the user can manually control a first part of the number of cores 30 to aim at a line shaped groove 200 of the line shaped screw 2, and can control other part of the number of cores 30 to rest on an upper surface of line shaped screw 2. When the button 40 is pressed, the button 40 can drive the first part of the number of cores 30 to move toward to a bottom of the line shaped groove 200. Therefore, when the first part of the number of cores 30 are inserted in the line shaped groove 200, a line shaped head matching the line shaped screw 2 is formed by the first part of the number of cores 30 that are inserted in the line shaped groove 200.

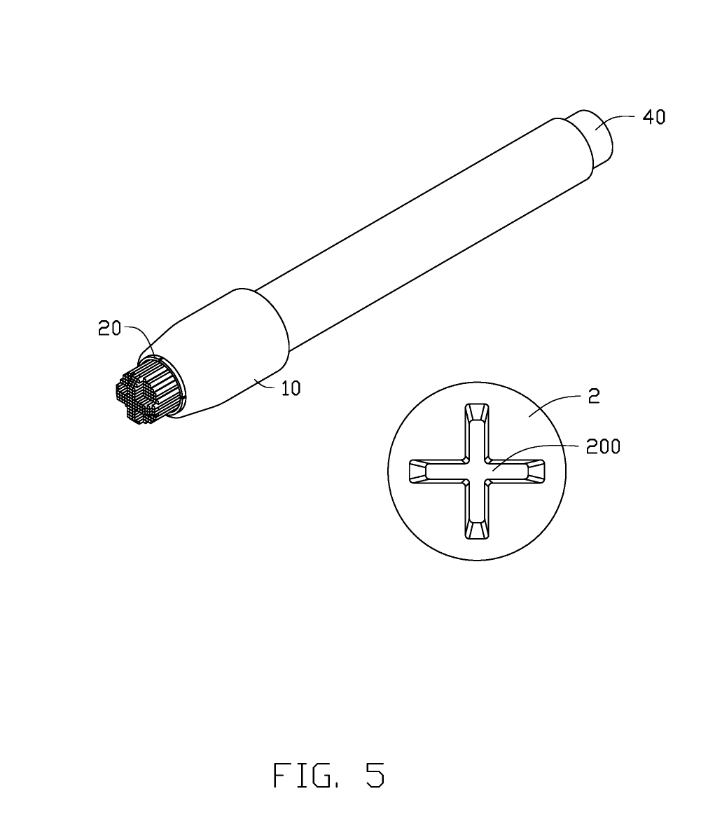

Refer to FIG. 5, when the user uses the screwdriver 1 to fasten a Phillips-headed or similar head shape (cross shaped screw 2), the user can manually control a first part of the number of cores 30 to aim at a cross shaped groove 200 of the cross shaped screw 2, and can control other part of the number of cores 30 to rest on an upper surface of cross shaped screw 2. When the button 40 is pressed, the button 40 can drive the first part of the number of cores 30 to move toward to a bottom of the cross shaped groove 200. Therefore, when the first part of the number of cores 30 are inserted in the cross shaped groove 200, a cross shaped head matching the cross shaped screw 2 is formed by the first part of the number of cores 30 that are inserted in the cross shaped groove 200.

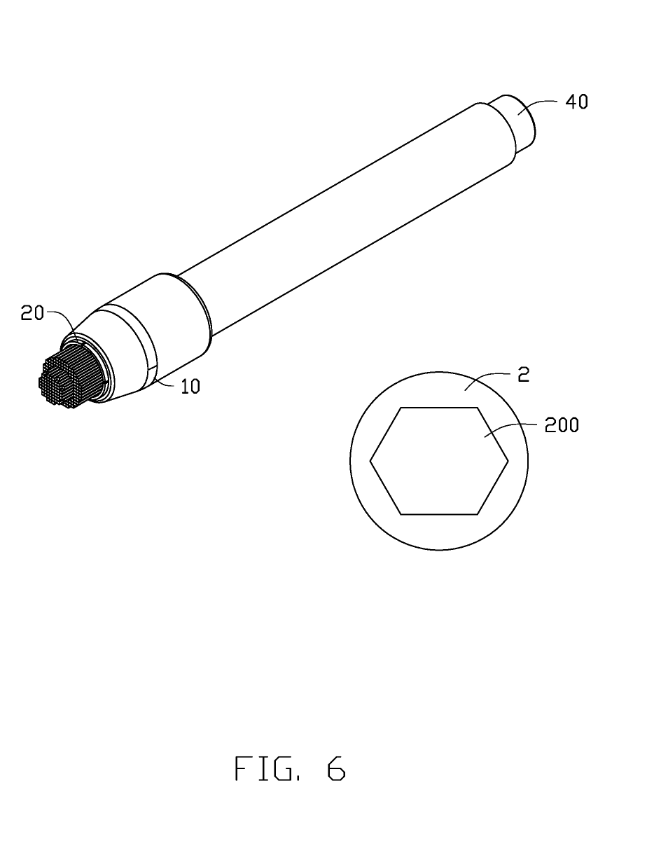

Refer to FIG. 6, when the user uses the screwdriver 1 to fasten a hexagon-headed screw (hexagon shaped screw 2), the user can manually control a first part of the number of cores 30 to aim at a hexagon shaped groove 200 of the hexagon shaped screw 2, and can control other part of the number of cores 30 to rest on an upper surface of hexagon shaped screw 2. When the button 40 is pressed, the button 40 can drive the first part of the number of cores 30 to move toward to a bottom of the hexagon shaped groove 200. Therefore, when the first part of the number of cores 30 are inserted in the hexagon shaped groove 200, a hexagon shaped head matching the hexagon shaped screw 2 is formed by the first part of the number of cores 30 that are inserted in the hexagon shaped groove 200.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size, and arrangement of parts within the principles of the present disclosure, up to and including the full extent established by the broad general meaning of the terms used in the claims.

What is claimed is:

1. A screwdriver comprising:
a fixing member; and
a main body;
wherein the main body comprises a first end and a second end, the fixing member fixes on the first end of the main body;
wherein the screwdriver further comprises:
a number of cores and a button, wherein the number of cores are contained in the main body and are partially exposed out of the main body, the button is configured on the second end of the main body and resists against one end of the number of cores, when the button is pressed, the button drives a part of the number of cores to form a head to match a screw.

2. The screwdriver as described in claim 1, wherein the fixing member is a hollowed cone body, and first screw thread is set on an internal surface of the fixing member.

3. The screwdriver as described in claim 2, wherein the main body is a hollowed cylinder, second screw thread is set on an external surface of the main body, the second screw thread matches the first screw thread, and the matching between the first screw thread and the second screw thread is configured to fix the fixing member on the main body.

4. The screwdriver as described in claim 1, wherein a plurality of through grooves are defined in the first end of the main body, the plurality of through grooves are parallel and equidistant from each other.

5. The screwdriver as described in claim 1, wherein the button has a cylinder shape and is made of elastic material.

6. The screwdriver as described in claim 1, wherein the main body is enclosed with a cover, and the cover is made of anti-slip material.

7. The screwdriver as described in claim 1, wherein a cross section of each of the number of cores has a square shape or a hexagon shape.
